(19) United States
(12) Patent Application Publication
(10) Pub. No.: US 2026/0170265 A1
(43) Pub. Date: Jun. 18, 2026

(54) Large Language Model (LLM) Token Truncation

(71) Applicant: PayPal, Inc., San Jose, CA (US)

(72) Inventors: Yuan Wang, Nanjing (CN); Chawannut Prommin, Singapore (SG)

(21) Appl. No.: 19/028,158

(22) Filed: Jan. 17, 2025

(30) Foreign Application Priority Data
Dec. 16, 2024 (WO) PCT/CN2024/139444

(51) Int. Cl. G06F 40/40

(52) U.S. Cl. CPC G06F 40/40

(57) ABSTRACT

Techniques are disclosed for dynamically managing token limits in Large Language Models (LLMs) using a Retrieval-Augmented Generation (RAG). In some embodiments, a computing system receives a query and retrieves relevant context articles via RAG. The system tokenizes the query and context articles to generate a set of input tokens for inclusion in an LLM prompt. A dynamic threshold is determined based on the input token quantity, which is used to truncate or adjust the token count if necessary. The threshold can be applied such that the total number of input and output tokens does not exceed the LLM’s limit. Additionally, a lookup table can be generated from training data that correlates input token ranges with corresponding truncation thresholds. The system improves token usage by dynamically adjusting thresholds based on the input data, improving LLM performance and scalability in handling diverse data inputs.

### PRIORITY CLAIM

The present application claims priority to PCT Appl. No. PCT/CN2024/139444, entitled “LARGE LANGUAGE MODEL (LLM) TOKEN TRUNCATION”, filed December 16, 2024, which is incorporated by reference herein in its entirety.

### BACKGROUND

### TECHNICAL FIELD

This disclosure relates generally to computer systems and, more specifically, to large language models (LLMs) using a Retrieval-Augmented Generation (RAG) algorithm.

### DESCRIPTION OF THE RELATED ART

Large Language Models (LLMs) have gained widespread adoption due to their advanced natural language processing (NLP) capabilities, enabling them to perform tasks such as language translation, question answering, and text summarization with minimal human intervention. LLMs are commonly used in applications like chatbots, document analysis, and content generation, where understanding and generating human language is critical. However, these models rely on token limitations, which constrain the amount of data they can process in a single input. To enhance their utility, Retrieval-Augmented Generation (RAG) architectures have been introduced. RAG systems complement LLMs by retrieving relevant external information, such as documents or web pages, before generating responses, thereby expanding the contextual knowledge base available to the LLM. This integration improves the relevance and accuracy of LLM-generated content, though managing input/output token constraints remains a challenge.

### BRIEF DESCRIPTION OF THE DRAWINGS

FIG. 1 is a block diagram illustrating a large language model (LLM) token truncation system for RAG-based LLM systems, according to some embodiments.

FIG. 2 is a block diagram illustrating an example process for servicing an LLM query, according to some embodiments.

FIG. 3 is a block diagram illustrating an example input and output token cluster, according to some embodiments.

FIG. 4 is a block diagram illustrating an example of a lookup table creation process, according to some embodiments.

FIGS. 5A-C are flow diagrams illustrating embodiments of methods implementing techniques described herein.

FIG. 6 is a block diagram illustrating elements of an exemplary computer system for implementing techniques described herein.

### DETAILED DESCRIPTION

Large Language Models (LLMs) and Retrieval-Augmented Generation (RAG) systems may be widely adopted in various applications due to their ability to generate human-like text responses, perform natural language processing tasks, and analyze large volumes of data. In some instances, RAG systems enhance LLM performance by retrieving contextually relevant information from large external data sources, such as documents or web pages. For example, RAG systems may rely on embeddings to facilitate this retrieval process. An embedding may represent a piece of text, such as a query or a document, as a multi-dimensional vector in a continuous vector space. By converting both the query and the available documents into embeddings, a RAG system may compare the query embedding to document embeddings (e.g., using techniques such as cosine similarity to measure the angular distance between vectors) allowing the system to identify the documents most similar to the query in multi-dimensional space. Once the most relevant documents are determined based on their proximity to the query embedding, the system may retrieve those documents (also referred to as context articles) for analysis by the LLM. In some cases, the system selects a fixed number of context articles (e.g., 1-4 documents (or document chunks)) that are closest in vector space to the query. In some instances, LLMs may face token constraints, where the total length of input and output tokens is limited, which may restrict the number of context articles or amount of input data that can be processed at once. To account for these limits, the number of input tokens may be truncated, which can result in less available context information being available to the LLM to service the LLM query. Current static token limits may thus result in inefficient handling of variable-length inputs, which can degrade the performance of the LLM when dealing with large or complex queries and their associated context articles.

The present disclosure describes systems and methods for dynamically determining token truncation thresholds based on the quantity of input tokens included in LLM prompts (e.g., based on the input query and context articles) for RAG-based LLM systems and applying these thresholds to improve token allocation between input and output data. In some embodiments, a system may receive a user query intended for processing by an LLM and retrieve relevant context articles through a RAG algorithm, which allows the LLM to integrate additional context from external sources. The system may then tokenize both the user query and the retrieved context article data, generating a set of input tokens for inclusion in an LLM prompt. In some examples, a dynamic threshold is determined such that the number of tokens reserved (e.g., for output tokens) can be adjusted for various input token ranges as well as for various numbers of context articles. This approach may allow for the efficient use of the LLM’s token limit, ensuring that as much relevant input data as possible is processed without exceeding the maximum token limit. In some cases, a lookup table may be generated that correlates ranges of input token quantities (and numbers of context articles) with corresponding output token thresholds. This lookup table may be referenced during real-time processing to select an optimal threshold for token allocation such that token resources may be managed efficiently for various input token sizes/quantities.

In some embodiments, the systems and methods described herein may offer several advantages over traditional static threshold approaches. By dynamically adjusting the token threshold based on the input data, the system may prevent the unnecessary truncation of input context articles, thus improving the accuracy and completeness of the LLM’s responses. By way of example, in scenarios where smaller inputs require fewer output tokens, the system may allocate more tokens to process additional input data (e.g., context article data) which may improve the overall quality of the generated output. As a result, the present disclosure may provide a significant improvement in the performance and scalability of LLM-based systems, allowing for more effective utilization of token resources in environments with diverse and variable data inputs.

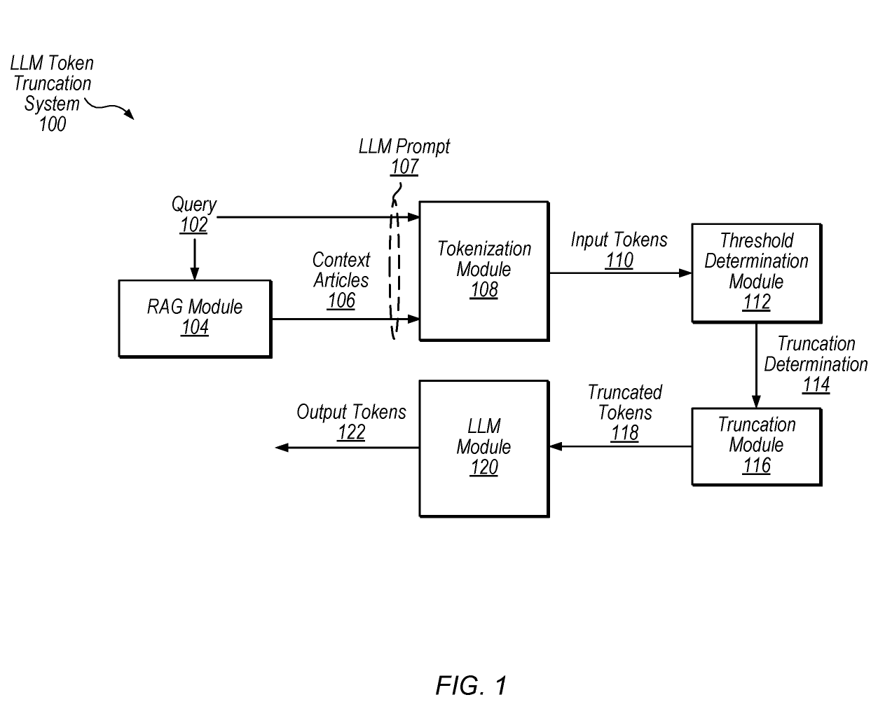

Turning now to FIG. 1, a block diagram of a large language model (LLM) token truncation system 100 from a RAG-based LLM system is depicted. In the illustrated embodiment of FIG. 1, LLM token truncation system 100 includes RAG module 104, tokenization module 108, threshold determination module 112, truncation module 116, and LLM module 120. In some aspects, LLM token truncation system 100 is designed to manage the input and output token limits of LLM module 120 to ensure efficient processing without exceeding the allowable token limits. In some cases, the components as illustrated in FIG. 1 work in conjunction to process a user query 102, retrieve context articles 106, tokenize the input data (e.g., via tokenization module 108), determine token thresholds (e.g., via threshold determination module 112), and, if necessary, truncate the input tokens (e.g., via truncation module 116) to meet the requirements of LLM 120’s token limit.

In some examples, query 102 represents a user input query (e.g., such as a text-based query), which may be input into RAG module 104 and tokenization module 108. The RAG module 104 may retrieve context articles 106 in response to query 102. In some embodiments, context articles 106 may come from one or more external data sources including, but not limited to, document stores, databases, web pages, etc. In the illustrated embodiment, context articles 106 are sent to tokenization module 108 for conversion into tokens or any other format suitable for processing by LLM module 120.

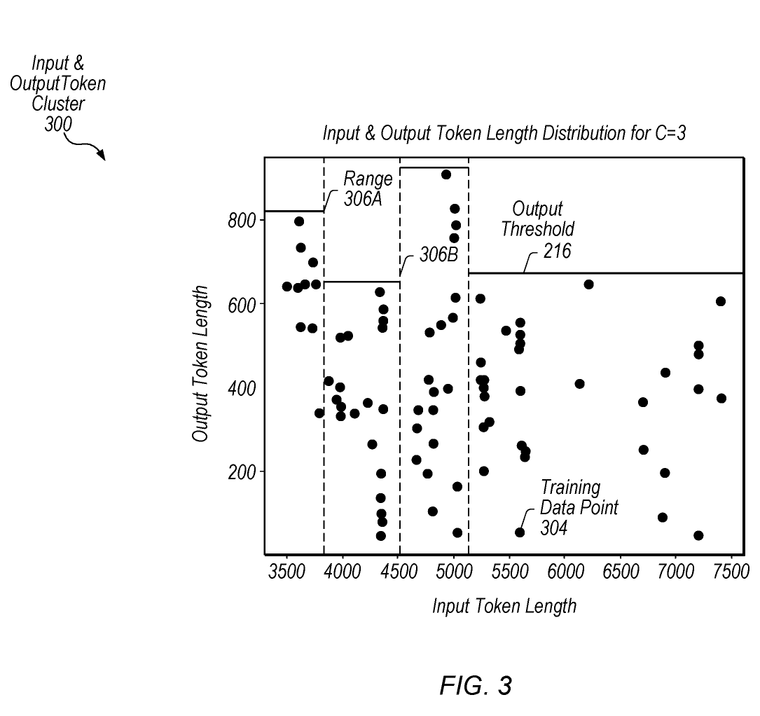

In some embodiments, context articles 106 may be derived from a fixed or variable number of context articles (e.g., relevant documents, references, web pages, or other data sources). For example, if C represents the number of context articles to be used and C=3, then system 100 (e.g., RAG module 104) may retrieve three context articles 106. In some examples, these references may be selected through a process that involves converting both query 102 and the potential context articles into embeddings (e.g., an embedding can represent text as a multi-dimensional vector in a continuous vector space). The RAG module 104 may then compare the embedding of query 102 with the embeddings of the context articles to identify those most relevant to the query (e.g., this comparison may be carried out using cosine similarity, which measures the angular distance between vectors). Context articles with embeddings that are closest to the query embedding in vector space (i.e., have the smallest angular distance) may be selected such that context articles 106 is contextually aligned with query 102. Further details about changing the number of context articles will be discussed in further detail with respect to FIG. 3 below.

In the illustrated embodiment, after query 102 and context articles 106 are retrieved, they are combined together in an LLM prompt 107, which is inputted into tokenization module 108, where the tokenization process begins. In some embodiments, tokenization module 108 converts the raw text and/or data of both query 102 and context articles 106 into tokens, which are numeric values indicative of units of text that can be processed by LLM module 120. In some examples, input tokens 110 represent the combined tokenized version of both query 102 and context articles 106. The output from tokenization module 108 labeled as input tokens 110 may be input to threshold determination module 112.

In some aspects, once input tokens 110 are generated, they may be passed to threshold determination module 112. Threshold determination module 112 may analyze the quantity of input tokens 110 and dynamically determine an appropriate threshold for token management. In some embodiments, threshold determination module 112 can calculate a threshold value, which may represent the maximum number of output tokens that may be produced or expected to be produced (e.g., based on past training data of input and output tokens) by LLM module 120 based on a corresponding range of values for quantities of input tokens 110. In some embodiments, this threshold is a function of the number of input tokens 110 and the total token limit of LLM module 120. For instance, if input tokens 110 consume a large portion of LLM module’s 120 total token capacity, the threshold for output tokens 122 (e.g., output from LLM module 120) may be reduced to ensure that the combined input token 110 and output token 122 quantity does not exceed LLM module’s 120 token quantity limit. This dynamic calculation may allow for flexibility in managing input token 110 and output token 122 sizes depending on the nature of query 102 and the retrieved context articles 106.

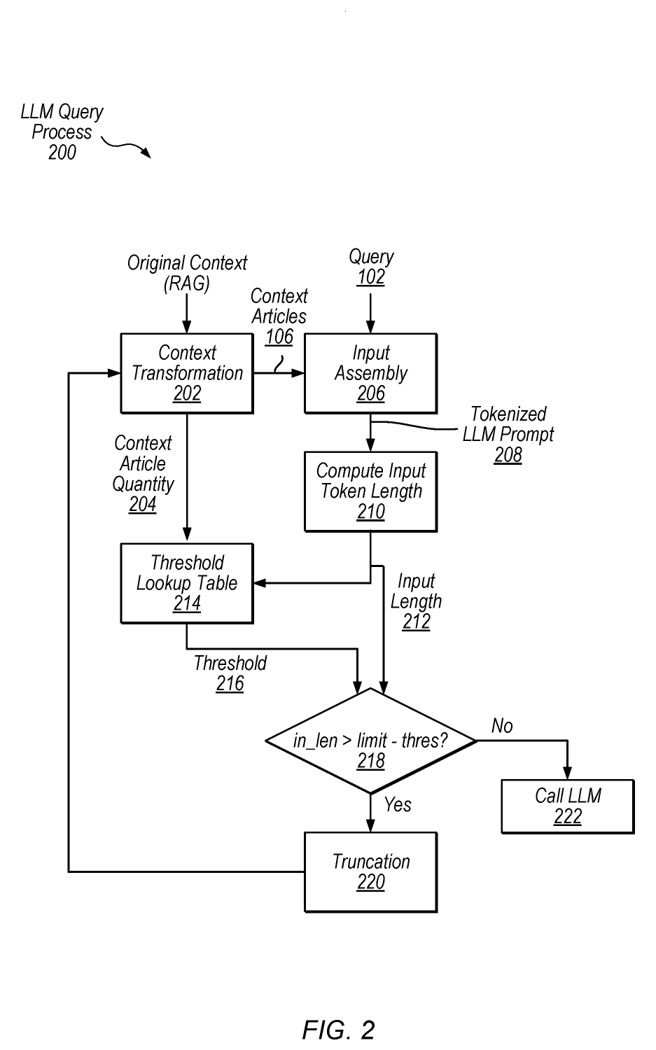

In some embodiments, threshold determination module 112 may reference a lookup table or use an algorithm that takes into account historical data (e.g., historical input token and/or output token data) and/or predefined rules to set the threshold value. In some examples, the lookup table may associate particular ranges of input token 110 quantities with a corresponding threshold value. In some embodiments, the lookup table may also include different truncation thresholds depending on the number of context articles, depending on the particular knowledge base source (or sources) providing context articles, the particular LLM being used if system 100 offers multiple selectable options of LLMs, the particular embedding algorithm used to encode context articles, etc. In some embodiments, the lookup table may also include different truncation thresholds based on the source of query 102. For example, system 100 may be accessible to a plurality of different clients, each able to submit queries 102 to system 100. As these clients may different needs (and different historical trends in LLM prompt and output sizes), the lookup table may store different truncation thresholds for different clients. These differing factors for determining a given truncation threshold may also affect which truncation technique is used as will be discussed.’ The lookup table will be discussed in further detail with respect to FIGS. 2-3 below.

After a threshold has been determined, system 100 may continue to truncation module 116 to evaluate whether the total number/quantity of input tokens 110 exceeds the allowable token limit (e.g., of LLM module 120). In some embodiments, truncation module 116 considers the threshold value (e.g., the maximum number or threshold of output tokens 122 based on input tokens 110) determined by threshold determination module 112. If the quantity of input tokens 110 exceeds the limit, truncation module 116 may reduce the number of input tokens 110 by removing tokens (e.g., such as removing tokens corresponding to context articles 106 and/or query 102). For example, GPT-3 LLM has a total token limit of 4096. If this LLM is being used, threshold determination module 112 may determine that a truncation threshold of 3300 token should be applied to a given LLM prompt in order to retain 1096 available tokens for the LLM output. If, however, the LLM prompt 107 includes 3500 tokens, truncation module 116 may attempt to reduce the size of the LLM prompt by 200 tokens in order to satisfy this threshold. This truncation process may help keep input tokens 110 within LLM module’s 120 capacity, preserving enough space for the generation of output tokens 122. In some cases, truncation module 116 may prioritize the retention of tokens associated with the user query 102 over the tokens derived from context articles 106.

The truncated tokens 118 of LLM prompt 107 may then be passed to LLM module 120 for processing. In some embodiments, LLM module 120 includes an LLM and may also include additional software components (e.g., in some embodiments, LLM module 120 may include software for truncating tokens as performed by truncation module 116). In scenarios where truncation is not needed, truncated tokens 118 may be equivalent to input tokens 110, meaning no tokens from input tokens 110 have been discarded or reduced. The output of LLM module 120 is a set of output tokens 122, which may represent a response to user query 102. In some examples, output tokens 122 may contain LLM module’s 120 generated text, which could be an answer, summary, and/or any other relevant output based on query 102 and/or context articles 106.

Turning now to FIG. 2, a block diagram illustrating an example process 200 for servicing an LLM query is depicted. In the illustrated embodiment of FIG. 2, LLM query process 200 comprises multiple components that work together to manage and truncate input tokens as necessary to ensure that the total number of tokens remains within a predefined token limit of the LLM. The one or more components as illustrated in FIG. 2 may be executed by a system 100.

In some aspects, process 200 begins at block 202 with the retrieval of context articles 106 from one or more knowledge base sources based on a given user query 102. In some cases, this step may be handled by context transformation block 202, which may process the relevant context data (e.g., context articles 106) pulled from one or more knowledge base sources. The context transformation block 202 may output context articles 106 that may be used in conjunction with the user’s query in the subsequent block.

In some cases, the output from context transformation block 202 along with the user’s query is input to input assembly block 206. In some embodiments, input assembly block 206 receives context articles 106 and query 102 and combines them into an LLM prompt 107. For example, the LLM prompt 107 may state “Answer this ‘query 102’ based on the following ‘context articles 116’.” In some cases, input assembly block 206 may tokenize the LLM prompt including the query and/or the context articles in order to produce a tokenized LLM prompt 208.

The combined tokens from input assembly block 206 may then be processed by compute input token length block 210, which may calculate the total number or length/quantity 212 of input tokens. The computed length may include the tokens from the query, the context articles, and any additional text in the LLM prompt 107. The total token count may then be passed to the next step in process 200 for further analysis.

In some embodiments, based on the computed input token length/quantity 212 from compute input token length block 210 as well as number/quantity 204 of context articles 106, threshold lookup table 214 may correlate the number of input tokens to a corresponding truncation threshold value (e.g., which may represent the maximum number of output tokens allowed). In some examples, the threshold value (shown as threshold 216) may be determined based on the token quantity 212(e.g., from the input tokens and/or output tokens), context article quantity 204, the particular knowledge base sources providing articles 106, and the token limits of the LLM, which may be one of a plurality of LLMs available for selection by a user submitting query 102. For example, the threshold lookup table may vary depending on the total number of input tokens (e.g., from the combination of the tokens from the query and context articles), which may enable the ability to dynamically adjust token thresholds as needed. Additional details on how the lookup table functions, including specific thresholds for various token ranges are discussed with respect to FIG. 3 below.

Once the threshold has been determined, process 200 continues to decision block 218, which may evaluate, in some embodiments, whether the total number of input tokens exceeds the difference between the token limit of the LLM and the threshold value retrieved from threshold lookup table 214. In the illustrated embodiments, threshold 216 is the number of tokens to be reserved for the LLM output; thus, the input threshold is the difference between the token limit of the LLM and threshold 216. By way of example, consider that the combined tokens from the query and context articles amount to 4000 tokens, and the corresponding threshold value (e.g., the expected maximum number of output tokens the LLM can generate) is 700 tokens (e.g., retrieved from threshold lookup table 214). Additionally, assume that the maximum token limit of the LLM is 4500 tokens. In this example, the difference between the token limit and the threshold is 4500 - 700 = 3800 tokens, meaning the LLM can handle up to 3800 input tokens. Since the input token count (4000 tokens) exceeds this limit, the condition of decision block 218 is satisfied, and process 200 continues to integer/fraction truncation block 220.

The integer/fraction truncation block 220 may truncate the number of input tokens such that the total number of tokens (e.g., the input tokens combined with the output tokens) remains within the limit of the LLM. In the example above, the input token count of 4000 tokens combined with 700 output tokens is 4700 tokens, which exceeds the allowable limit of 4500 tokens for the LLM. Therefore, integer/fraction truncation block 220 may truncate at least 200 tokens to bring the total input within the 4500 token limit of the LLM. In some embodiments, this truncation may involve reducing the number of tokens from the tokenized context articles (e.g., as illustrated in FIG. 2 via the arrow from integer/fraction truncation 220 block to context transformation block 202). In some embodiments, the system may prioritize preserving tokens from the query and remove tokens from the context articles first. For example, less relevant portions of the tokenized context articles may be discarded. Alternatively, in some embodiments, the context articles may be summarized by sending it to an LLM, which may reduce the overall token count of the context articles. Another method may involve selectively truncating a subset of the context articles tokens, ensuring that the most relevant parts of the context articles are retained while complying with the LLM’s token constraints. In some embodiments, the tokens corresponding to the query may also be reduced if necessary, following the same methods as described for the context articles tokens. After truncation via integer/fraction truncation block 220, the modified input tokens (now equal to or fewer than the allowable 4500 tokens) may be passed to the LLM as shown by call LLM block 222.

On the other hand, if decision block 218 determines that the number of input tokens does not exceed the allowable limit, process 200 may skip truncation and proceed directly to call LLM block 222. For example, consider an LLM with a 4500 token limit where the total number of input tokens is 3000, and the threshold value for output tokens is 800. In this example, the difference between the token limit and the threshold is 4500 - 800 = 3700 tokens. Since the input token count of 3000 is less than the allowable 3700 tokens, the condition for truncation is not satisfied. As such, the input tokens may be passed directly to call LLM 222 without any truncation. In some embodiments, if there are extra tokens available (e.g., 3700 allowable tokens minus the 3000 input tokens = 700 extra tokens), additional tokens may be extracted or retrieved from the context articles, effectively increasing the number of context articles tokens processed by the LLM. In some embodiments, additional tokens may be retrieved from the user query (e.g., in a scenario where process 200 truncates tokens corresponding to the user query).

Turning now to FIG. 3, a block diagram illustrating an example input and output token cluster 300 is depicted. In the illustrated embodiment of FIG. 3, the X-axis represents the input token length or quantity (e.g., the combined token quantity of the query 102 and context articles 106), while the Y-axis represents the corresponding output token length (e.g., quantity of output tokens 122). In some aspects, each data point 304 corresponds to a particular input token length and its associated output token length.

In some embodiments, a clustering algorithm such as K-means algorithm may be applied to these scattered data points 304 to group them into various clusters. In the illustrated embodiment of FIG. 3, there are four groupings, each containing a similar number of data points 304, with the clusters/groups separated by vertical lines (e.g., vertical lines 306A and 306B). Each grouping may correspond to a specific range of input token lengths and for each range, a maximum output token length is indicated by horizontal lines (e.g., horizontal line 302). In addition to a K-means algorithm, addition clustering algorithms may include, but are not limited to, hierarchical clustering, DBSCAN (Density-Based Spatial Clustering of Applications with Noise), and Gaussian clustering to group data points 304 based on different characteristics and/or criteria which may result in varying numbers of clusters/groups. Those skilled in the art will appreciate additional types of clustering algorithms that may adjust the number of groupings and/or the size of each group.

In the illustrated embodiment of FIG. 3, different ranges of input token lengths corresponding to different maximum output token lengths is depicted. For example, the grouping between vertical lines 306A and 306B represents a range of input token lengths for which the corresponding maximum output token length is shown by horizontal line 302 (e.g., the maximum quantity of output tokens for the range of input token quantities between 306A and 306B). In some instances, horizontal line 302 may exceed the maximum data point 304 within the input token range between lines 306A and 306B (e.g., horizontal line 302 as shown in FIG. 3 sits slightly above the highest data point 304 in that respective input token length range). Threshold lookup table 214 as described above with respect to FIG. 2 may store this threshold value (e.g., horizontal line 302) for input token lengths that fall within the corresponding range (e.g., between lines 306A and 306B).

As shown in the illustrated example of FIG. 3, this particular example uses C=3 context articles, meaning that contextual data has been retrieved from three distinct sources/references. In other embodiments, a different number of context articles may be used, resulting in a different set of data points 304 (e.g., a different scattering of data points 304 for input and output token lengths than the illustrated embodiment of FIG. 3).

In some embodiments, the data as illustrated in FIG. 3 can be used to populate a lookup table (e.g., threshold lookup table 214). For example, the lookup table may correlate various input token lengths with their corresponding output token lengths or threshold values for various numbers of context articles (e.g., C=2, C=3, C=4, etc.). In various embodiments, the lookup table can also include truncation threshold values based additional factors. For example, the lookup table may include different truncation threshold values based on the source of context articles such that system 100 can receive an indication identifying one or more of the sources of context articles and dynamically determine the truncation threshold value based on the identified one or more sources. As another example, the lookup table may include different truncation threshold values for multiple LLMs supported by system 100 such that system 100 can receive a selection identifying a particular one of the LLMs to process an LLM prompt 107 and dynamically determine the truncation threshold is based on the particular LLM identified by the received selection.

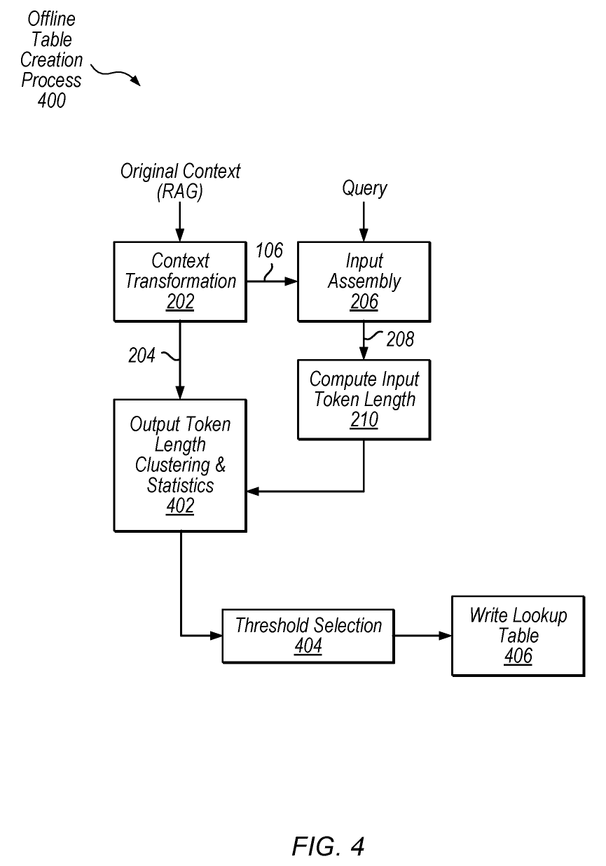

Turning now to FIG. 4, an example of an offline lookup table creation process 400 is depicted. In the illustrated embodiment of FIG. 4, the lookup table creation process 400 begins similarly to the token processing as discussed above in FIG. 2. For example, context transformation block 202, input assembly block 206, and compute input token length block 206 operate as described above with respect to FIG. 2. In these steps, the original context data from the RAG system and the user query are assembled and tokenized, and the total input token length is computed.

In some embodiments, following the computation of input token length, process 400 proceeds to output token length clustering & statistics block 402. In some aspects, output token length clustering & statistics block 402 may perform clustering and statistical analysis on the output token lengths generated by the LLM in response to different input token lengths. For example, various clustering algorithms including, but not limited to, K-means, DBSCAN, hierarchical clustering, and Gaussian clustering may be used to group the token lengths into clusters/groups, which may be used for determining token thresholds (e.g., a maximum output token length for corresponding input token lengths).

After clustering the data, process 400 continues to threshold selection block 404, which may determine appropriate threshold values based on the clustering results. By way of example, these thresholds may represent the maximum allowable output token lengths for different ranges of input token lengths (e.g., as discussed with respect to FIG. 3, a specific cluster of input token lengths may correspond to a threshold that limits the output token length for the range of input token lengths in that cluster).

Next, write lookup table block 406 may store the computed thresholds in a lookup table that correlates various input token lengths with their corresponding output token thresholds. As discussed above with respect to FIG. 3, the lookup table may correlate various input token lengths with their corresponding output token lengths or threshold values for various numbers of references (e.g., C=2, C=3, C=4, etc.) and provide the ability to dynamically adjust the token limits based on the input and output characteristics of the LLM.

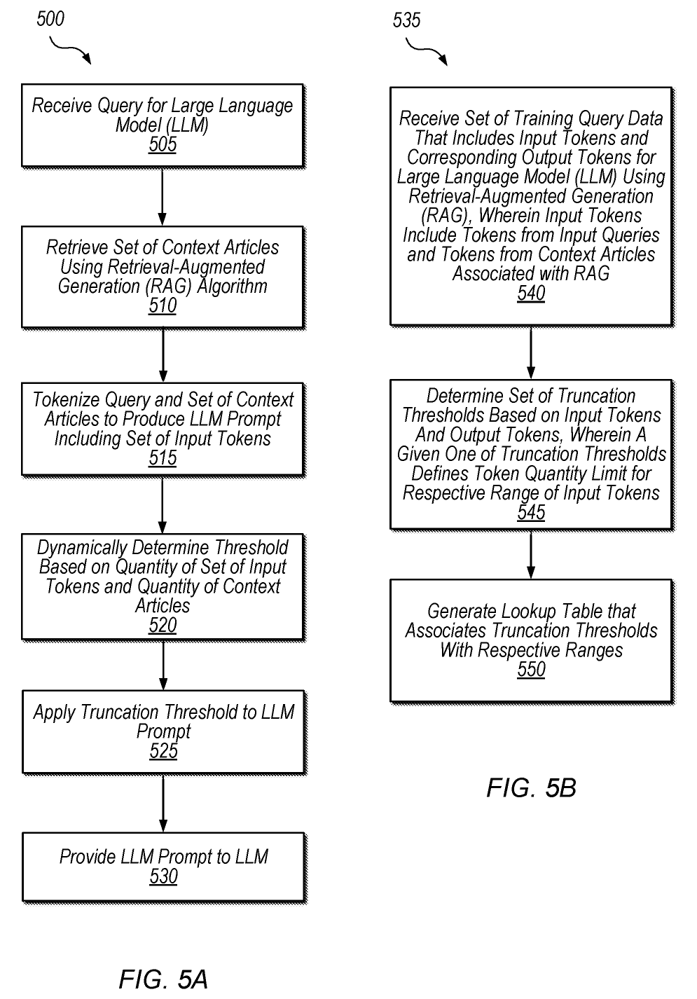

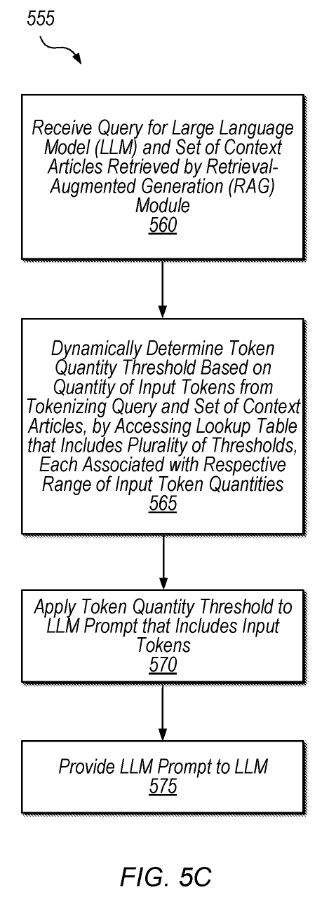

Turning now to FIG. 5A, a flow diagram of a method 500 is shown. Method 500 is one embodiment of a method performed by a computing system 600. Method 500 may be performed by executing a set of program instructions stored on a non-transitory computer-readable medium. In some instances, performance of method 500 may improve the performance of a RAG-based LLM system.

Method 500 begins in step 505 with the computing system receiving a query for a Large Language Model (LLM). For example, LLM token truncation system 100 may receive a user query 102 for a LLM 120.

In step 510, the computing system retrieves a set of context articles using a Retrieval-Augmented Generation (RAG) algorithm. For example, LLM token truncation system 100 may use RAG module 104 to retrieve context articles 106 from external data sources, such as documents, web pages, or databases. The RAG module 104 may process the query 102 and convert it into an embedding, which may be compared against embeddings of the context articles. Using techniques such as cosine similarity, system 100 may identify the most relevant references and retrieve a set of context articles that will be tokenized for further processing by the LLM.

In step 515, the computing system tokenizes a set of context articles using a Retrieval-Augmented Generation (RAG) algorithm. For example, LLM token truncation system 100 may use tokenization module 108 to convert the user query 102 and/or the retrieved context articles 106 into input tokens 110. This process may involve breaking down the text of the query and references into smaller, processable units (tokens) that the LLM can analyze. The combined set of input tokens 110 may represent the tokenized form of the query and the context articles, which is then passed to the next stage for further processing.

In step 520, the computing system dynamically determines a set of context articles using a Retrieval-Augmented Generation (RAG) algorithm. For example, LLM token truncation system 100 may use threshold determination module 112 to analyze the quantity of input tokens 110 generated from the query 102 and context articles 106. In some embodiments, the threshold determination module 112 may dynamically calculate a threshold value tokens (e.g., horizontal line 302) that represents the maximum number of output tokens that can be generated based on the number of input. In some cases, the threshold value is determined by referencing historical data and/or a lookup table, which can correlate ranges of input token quantities with corresponding output token thresholds. As such, the threshold may enable the total number of token to remain within the LLM’s token limit.

In step 525, the computing system applies the truncation threshold to the LLM prompt. For example, LLM token truncation system 100 may compare the quantity of input tokens 110 against the dynamically determined threshold from threshold determination module 112. If the quantity of input tokens exceeds the threshold, the system may initiate a truncation process to reduce the number of input tokens, ensuring that the total token count (input tokens 110 and/or output tokens 122) remains within the LLM’s token limit.

In step 530, the computing system provides the LLM prompt to the LLM. For example, the input tokens may be provided to LLM module 120.

In some embodiments, the operations further comprise receiving an indication identifying one or more of a plurality of sources of context articles. For example, system 100 may receive an indication specifying one or more data sources that provide context articles, such as a particular document database, knowledge base, and/or other data repository. This indication may be used by RAG module 104 to retrieve context articles 106 tailored to the specified sources, such that the retrieved context is relevant to the selected data sources. In some embodiments, the dynamic determining of the truncation threshold is additionally based on the identified one or more sources. For example, system 100 may access threshold lookup table 214 and select a truncation threshold based on the identified source of context articles 106, where different sources may have distinct thresholds tailored to the characteristics of data retrieved by RAG module 104.

In some embodiments, the operations further comprise receiving a selection identifying a particular one of a plurality of LLMs to process the LLM prompt. For example, system 100 may receive a selection specifying a particular LLM module 120, with threshold determination module 112 then accessing lookup table 214 to select a truncation threshold suited to the selected LLM's token capacity and processing characteristics. In some embodiments, the dynamic determining of the truncation threshold is additionally based on the particular LLM identified by the received selection. For example, threshold determination module 112 may adjust the truncation threshold according to the token processing limits specific to the selected LLM module 120 (e.g., as referenced in lookup table 214), to optimize token allocation for that particular LLM’s configuration.

In some embodiments, the dynamic determining of the truncation threshold is additionally based on a set of training data including a training set of LLM prompts and a training set of corresponding outputs. For example, threshold determination module 112 may use historical training data, which may include prior LLM prompts and their corresponding output token quantities, to predict an appropriate truncation threshold for current input tokens, referencing patterns stored in threshold lookup table 214.

In some embodiments, the dynamic determining includes accessing a lookup table that includes a plurality of truncation thresholds, each associated with a respective range of input token quantities and identifying a particular one of the truncation thresholds in response to the set of input tokens falling within the range associated with the particular truncation threshold. For example, LLM token truncation system 100 may reference threshold lookup table 214 to access a truncation threshold that may correspond to the range encompassing the total number of input tokens in the LLM prompt, dynamically selecting the appropriate threshold based on the token count.

In some embodiments, the applying further includes truncating the set of input tokens in response to the quantity of tokens satisfying the truncation threshold. For example, as illustrated in decision block 218, system 100 may determine that the input token count exceeds the threshold derived from lookup table 214, which may trigger truncation module 116 to reduce the input tokens, such as by prioritizing the removal of tokens associated with context articles 106. In some embodiments, the truncating includes providing tokens corresponding to the set of context articles to the LLM to generate a summary of the set of context articles and tokenizing the summary to produce a summarized set of input tokens, wherein the LLM prompt includes the summarized set of input tokens. For example, LLM token truncation system 100 may input context articles 106 into LLM module 120 to generate a summary. The system 100 may then tokenize this summary and incorporate the resulting summarized tokens as part of the final set of input tokens 110 included in LLM prompt 107 for further processing. In some embodiments, the truncating includes selecting a portion of a given context article, wherein the providing the LLM prompt includes providing, for the given context article, tokens from only the selected portion. For example, LLM token truncation system 100 may analyze context articles 106 to identify key sections most relevant to query 102. System 100 may then tokenize only these selected portions, incorporating the relevant tokens into the final set of input tokens 110 for inclusion in LLM prompt 107, such that only essential content is processed by LLM module 120.

In some embodiments, the truncated set of input tokens are generated by reducing the number of tokens corresponding to the set of context articles without reducing the number of tokens corresponding to the query. For example, truncation block 220 may reduce input tokens only corresponding to query 102. In some embodiments, the manner in which truncation is implemented by vary based on the source of a given query. For example, system 100 may be accessible by a first client that wants system 100 to truncate context articles by using the LLM to summarize them. The system 100 may also be accessible by a second client that wants system 100 to employ a different chunking size, so that retrieved context articles include fewer tokens. Given these differing preferences, system 100 may use different truncation techniques based on whether a given query 102 is received from the first client or the second client.

Turning now to FIG. 5B, a flow diagram of a method 535 is shown. Method 535 is one embodiment of a method performed by a computing system (e.g., computing system 600) and may be performed by executing a set of program instructions stored on a non-transitory computer-readable medium. In some instances, performance of method 535 may improve the performance of a RAG-based LLM system.

Method 535 begins in step 540 with the computing system (e.g., computing system 600) receiving a set of training query data that includes input tokens and corresponding output tokens for a Large Language Model (LLM) using Retrieval-Augmented Generation (RAG). For example, LLM token truncation system 100 may gather historical data, including tokenized queries 102 and context articles 106 processed by tokenization module 108, and output tokens 122 generated by LLM module 120. In some embodiments, the input tokens include tokens from input queries and tokens from context articles associated with the RAG. For example, the input tokens may consist of tokens derived from both user queries 102 and/or tokens from context articles 106, which may be retrieved and processed by RAG module 104 before being tokenized by tokenization module 108.

In step 545, the computing system determines a set of truncation thresholds based on the input tokens and the output tokens. For example, LLM token truncation system 100 may analyze input tokens 110 from tokenized queries 102 and context articles 106, as well as the corresponding output tokens 122 generated by LLM module 120. In some embodiments, a given one of the truncation thresholds defines a token quantity limit for a respective range of input tokens in a given query. For example, LLM token truncation system 100 may use threshold determination module 112 to analyze the historical relationship between the input tokens 110 and the corresponding output tokens 122. Based on this analysis, the system 100 may assign a truncation threshold that correlates with a specific range of input token quantities such that the total token count stays within the LLM’s processing limits.

In step 550, the computing system generates a lookup table that associates the truncation thresholds with their respective ranges. For example, LLM token truncation system 100 may use threshold determination module 112 to compile a lookup table, such as lookup table 214, that maps each truncation threshold to a specific range of input token quantities.

In some embodiments, the set of truncation thresholds includes a first set of truncation thresholds associated with a first number of context articles retrievable using RAG and a second set of truncation thresholds associated with a second number of context articles retrievable using RAG. For example, LLM token truncation system 100 may retrieve context articles 106 from a set number of context articles, such as C=3, and apply a first truncation threshold. If a different number of context articles is retrieved, such as C=5, system 100 may apply a second truncation threshold from lookup table 214 that corresponds to the larger number of context articles. In some embodiments, determining the set of truncation thresholds for the respective range of input tokens includes applying a clustering algorithm to the input tokens and the output tokens. For example, LLM token truncation system 100 may apply a clustering algorithm, such as K-means or hierarchical clustering, to group input tokens 110 and corresponding output tokens 122 into clusters/groups based on their token lengths. These clusters may then be used to determine appropriate truncation thresholds for different ranges of input tokens.

In some embodiments, the clustering algorithm is a K-means clustering algorithm. For example, LLM token truncation system 100 may implement a K-means clustering algorithm to group input and output token data points in threshold lookup table 214. In some embodiments, the clustering algorithm is a Gaussian clustering algorithm. For example, LLM token truncation system 100 may utilize a Gaussian clustering algorithm to organize input and output token data points within threshold lookup table 214.

In some embodiments, method 535 further includes steps for receiving a query for the LLM and a corresponding set of context articles associated with the RAG and choosing a particular truncation threshold within the lookup table based on a number of input tokens from tokenizing the received query and the set of context articles. For example, LLM token truncation system 100 may receive a user query 102 and retrieve context articles 106 using RAG module 104. The system 100 may tokenize both the query and the set of context articles, and based on the resulting total number of input tokens 110, select a corresponding truncation threshold from lookup table 214 before processing the tokens in LLM module 120.

Turning now to FIG. 5C, a flow diagram of a method 555 is shown. Method 555 is one embodiment of a method performed by a computing system (e.g., computing system 600) and may be performed by executing a set of program instructions stored on a non-transitory computer-readable medium. In some instances, performance of method 555 may improve the performance of a RAG-based LLM system.

Method 555 begins in step 560 with the computing system (e.g., computing system 600) receiving a query for a Large Language Model (LLM) and a set of context articles retrieved by a Retrieval-Augmented Generation (RAG) module. For example, LLM token truncation system 100 may receive a user query 102 and retrieve context articles 106 from one or more sources/references using RAG module 104.

In step 565, method 555 dynamically determines a token quantity threshold based on a quantity of input tokens from tokenizing the query and the set of context articles, by accessing a lookup table that includes a plurality of thresholds, each associated with a respective range of input token quantities. For example, LLM token truncation system 100 may access threshold lookup table 214 and select the appropriate threshold based on the total number of input tokens 110, which include both tokenized query 102 and tokenized context articles 106

In step 570, method 555 applies the token quantity threshold to an LLM prompt that includes the input tokens. For example, LLM token truncation system 100 may apply the selected token quantity threshold to LLM prompt 107, which may include input tokens 110 such that the prompt remains within the LLM's token limit for processing in LLM module 120.

In step 575, method 555 provides the input tokens to the LLM. For example, after applying the threshold, LLM token truncation system 100 may send the truncated or unmodified input tokens 110 to LLM module 120 for processing, which may allow the LLM to generate a response based on query 102 and context articles 106.

In some embodiments, the applying includes truncating the input tokens in response to the quantity of input tokens exceeding the dynamically determined threshold. For example, if the total quantity of input tokens 110 in LLM prompt 107 exceeds the dynamically determined threshold, LLM token truncation system 100 may invoke truncation module 116 to reduce the token count before the prompt is processed by LLM module 120. In some embodiments, the truncated input tokens are generated by reducing the number of tokens corresponding to the set of context articles without reducing the number of tokens corresponding to the query. For example, LLM token truncation system 100 may prioritize preserving tokens from user query 102 and reduce tokens only from context articles 106, such that the query remains fully intact while managing the total token count within the threshold. In some embodiments, truncating further includes providing the input tokens corresponding to the set of context articles to the LLM to summarize the set of context articles. For example, LLM token truncation system 100 may input context articles 106 into LLM module 120 to generate a summarized version, which may then be tokenized and included as part of the final set of input tokens in LLM prompt 107.

In some embodiments, the lookup table is generated via a clustering algorithm applied to a set of previously received queries and corresponding outputs. For example, LLM token truncation system 100 may use a clustering algorithm such as K-means or hierarchical clustering to group previously received input tokens 110 and corresponding output tokens 122 into clusters. These clusters may then be used to generate lookup table 214, which may associate specific input token ranges with truncation thresholds based on the historical data.

In some embodiments, the plurality of thresholds includes a first set of truncation thresholds associated with a first number of context articles retrieved using RAG and a second set of truncation thresholds associated with a second number of context articles using RAG. For example, LLM token truncation system 100 may retrieve context articles 106 based on a set number of articles, such as C=3, and apply a first set of truncation thresholds. If a different number of context articles, such as C=5, is retrieved, the system 100 may apply a second set of truncation thresholds from lookup table 214 corresponding to the increased number of articles.

### Exemplary Computer System

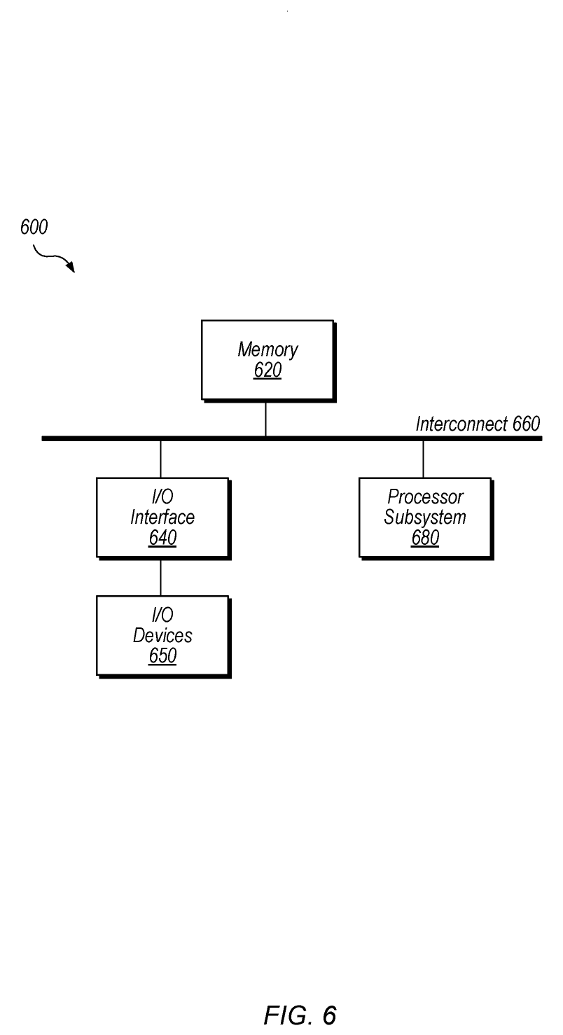

Turning now to FIG. 6, a block diagram of an exemplary computer system 600, which may implement system 100 (or one or more components included in systems 100), is depicted. Computer system 600 includes a processor subsystem 680 that is coupled to a system memory 620 and I/O interfaces(s) 640 via an interconnect 660 (e.g., a system bus). I/O interface(s) 640 is coupled to one or more I/O devices 650. Although a single computer system 600 is shown in FIG. 6 for convenience, system 600 may also be implemented as two or more computer systems operating together.

Processor subsystem 680 may include one or more processors or processing units. In various embodiments of computer system 600, multiple instances of processor subsystem 680 may be coupled to interconnect 660. In various embodiments, processor subsystem 680 (or each processor unit within 680) may contain a cache or other form of on-board memory.

System memory 620 is usable store program instructions executable by processor subsystem 680 to cause system 600 perform various operations described herein. System memory 620 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 600 is not limited to primary storage such as memory 620. Rather, computer system 600 may also include other forms of storage such as cache memory in processor subsystem 680 and secondary storage on I/O Devices 650 (e.g., a hard drive, storage array, etc.). In some embodiments, these other forms of storage may also store program instructions executable by processor subsystem 680. In some embodiments, program instructions that when executed implement elements of systems 100 (e.g., elements 130, 140, 170, 420, 430, etc.) may be included/stored within system memory 620.

I/O interfaces 640 may be any of various types of interfaces configured to couple to and communicate with other devices, according to various embodiments. In one embodiment, I/O interface 640 is a bridge chip (e.g., Southbridge) from a front-side to one or more back-side buses. I/O interfaces 640 may be coupled to one or more I/O devices 650 via one or more corresponding buses or other interfaces. Examples of I/O devices 650 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device 650 (e.g., configured to communicate over Wi-Fi^{®}, Bluetooth^{®}, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of … w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of … w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A non-transitory computer-readable medium having program instructions stored thereon that are capable of causing a computer system to perform operations comprising:
receiving a query for a Large Language Model (LLM);
based on the query, retrieving a set of context articles using a Retrieval-Augmented Generation (RAG) algorithm;
tokenizing the query and the set of context articles to produce an LLM prompt including a set of input tokens;
dynamically determining a truncation threshold based on the quantity of the set of input tokens and the quantity of context articles;
applying the truncation threshold to the LLM prompt; and
providing the LLM prompt to the LLM.

2. The non-transitory computer-readable medium of claim 1, wherein the operations further comprise:
receiving an indication identifying one or more of a plurality of sources of context articles, wherein the dynamic determining of the truncation threshold is additionally based on the identified one or more sources.

3. The non-transitory computer-readable medium of claim 1, wherein the operations further comprise:
receiving a selection identifying a particular one of a plurality of LLMs to process the LLM prompt, wherein the dynamic determining of the truncation threshold is additionally based on the particular LLM identified by the received selection.

4. The non-transitory computer-readable medium of claim 1, wherein the dynamic determining of the truncation threshold is additionally based on a set of training data including a training set of LLM prompts and a training set of corresponding outputs.

5. The non-transitory computer-readable medium of claim 1, wherein the dynamic determining includes:
accessing a lookup table that includes a plurality of truncation thresholds, each associated with a respective range of input token quantities; and
identifying a particular one of the truncation thresholds in response to the set of input tokens falling within the range associated with the particular truncation threshold.

6. The non-transitory computer-readable medium of claim 1, wherein the applying includes:
truncating the set of input tokens in response to the quantity of tokens satisfying the truncation threshold, wherein the truncating includes:
providing tokens corresponding to the set of context articles to the LLM to generate a summary of the set of context articles; and
tokenizing the summary to produce a summarized set of input tokens, wherein the LLM prompt includes the summarized set of input tokens.

7. The non-transitory computer-readable medium of claim 6, wherein the truncated set of input tokens are generated by reducing the number of tokens corresponding to the set of context articles without reducing the number of tokens corresponding to the query.

8. The non-transitory computer-readable medium of claim 1, wherein the applying includes:
truncating the set of input tokens in response to the quantity of tokens satisfying the truncation threshold, wherein the truncating includes:
selecting a portion of a given context article, wherein the providing the LLM prompt includes providing, for the given context article, tokens from only the selected portion.

9. A non-transitory computer-readable medium having program instructions stored thereon that are capable of causing a computer system to perform operations comprising:
receiving a set of training query data that includes input tokens and corresponding output tokens for a Large Language Model (LLM) using Retrieval-Augmented Generation (RAG), wherein the input tokens include tokens from input queries and tokens from context articles associated with the RAG;
determining a set of truncation thresholds based on the input tokens and the output tokens, wherein a given one of the truncation thresholds defines a token quantity limit for a respective range of input tokens in a given query; and
generating a lookup table that associates the truncation thresholds with their respective ranges.

10. The non-transitory computer-readable medium of claim 9, wherein the set of truncation thresholds includes a first set of truncation thresholds associated with a first number of context articles retrievable using RAG and a second set of truncation thresholds associated with a second number of context articles retrievable using RAG.

11. The non-transitory computer-readable medium of claim 9, wherein determining the set of truncation thresholds for the respective range of input tokens includes applying a clustering algorithm to the input tokens and the output tokens.

12. The non-transitory computer-readable medium of claim 11, wherein the clustering algorithm is a K-means clustering algorithm.

13. The non-transitory computer-readable medium of claim 11, wherein the clustering algorithm is a Gaussian clustering algorithm.

14. The non-transitory computer-readable medium of claim 9, wherein the operations further comprise:
receiving a query for the LLM and a corresponding set of context articles associated with the RAG; and
choosing a particular truncation threshold within the lookup table based on a number of input tokens from tokenizing the received query and the set of context articles.

15. A computer-implemented method comprising:
receiving a query for a Large Language Model (LLM) and a set of context articles retrieved by a Retrieval-Augmented Generation (RAG) module;
dynamically determining a token quantity threshold based on a quantity of input tokens from tokenizing the query and the set of context articles, by accessing a lookup table that includes a plurality of thresholds, each associated with a respective range of input token quantities;
applying the token quantity threshold to an LLM prompt that includes the input tokens; and
providing the LLM prompt to the LLM.

16. The computer-implemented method of claim 15, wherein the applying includes:
truncating the input tokens in response to the quantity of input tokens exceeding the dynamically determined threshold.

17. The computer-implemented method of claim 16, wherein the truncated input tokens are generated by reducing the number of tokens corresponding to the set of context articles without reducing the number of tokens corresponding to the query.

18. The computer-implemented method of claim 16, wherein the truncating includes:
providing the input tokens corresponding to the set of context articles to the LLM to summarize the set of context articles.

19. The computer-implemented method of claim 15, wherein the lookup table is generated via a clustering algorithm applied to a set of previously received queries and corresponding outputs.

20. The computer-implemented method of claim 15, wherein the plurality of thresholds includes a first set of truncation thresholds associated with a first number of context articles retrieved using RAG and a second set of truncation thresholds associated with a second number of context articles using RAG.
